(19) United States
(12) Patent Application Publication
(10) Pub. No.: US 2016/0274999 A1
(43) Pub. Date: Sep. 22, 2016

(54) DISTRIBUTED TEST AND PROFILER FRAMEWORK

(71) Applicant: Samsung Electronics Co., Ltd., Suwon-si (KR)

(72) Inventor: German FLOREZ-LARRAHONDO, Georgetown, TX (US)

(21) Appl. No.: 14/548,265

(22) Filed: Nov. 19, 2014

Related U.S. Application Data
(60) Provisional application No. 62/000,998, filed on May 20, 2014.

(51) Int. Cl. G06F 11/36; G06F 9/445; H04L 29/08

(52) U.S. Cl. CPC G06F 11/3664; H04L 67/10; G06F 8/61; G06F 11/3688; G06F 11/3692

(57) ABSTRACT

According to one general aspect, a method may include receiving a distributed application installation package. The distributed application installation package may include a distributed application installation file, a support program for the distribute application, and one or more configuration settings. The method may include installing at least the distributed application on a cluster of computing devices, such that the distributed application, when running, executes in a sandbox environment. The method may also include profiling a performance of the distributed application by executing, via the distribute application and within the sandbox environment on the cluster of computing devices, one or more tests. The method may further include generating a performance summary of the distributed application by collecting one or more pieces of profiled data generated during the execution of the one or more tests.

### CROSS-REFERENCE TO RELATED APPLICATION

This application claims priority under 35 U.S.C. §119 to Provisional Patent Application Ser. No. 62/000,998, entitled “DISTRIBUTED TEST AND PROFILER FRAMEWORK” filed on May 20, 2014. The subject matter of this earlier filed application is hereby incorporated by reference.

### TECHNICAL FIELD

This description relates to distributed computing, and more specifically to the set-up and testing of a distributed application.

### BACKGROUND

Distributed computing is generally a field of computer science that studies or utilizes distributed systems. A distributed system is traditionally a system in which components located on networked computers communicate and coordinate their actions by passing messages amongst themselves. The components interact with each other in order to achieve a common goal. General characteristics of distributed systems may include concurrency of components, lack of a global clock, and independent failure of components. Examples of distributed systems vary from massively multiplayer online games to peer-to-peer applications.

The word “distributed” in terms such as “distributed system”, “distributed programming”, “distributed algorithm”, etc. originally referred to computer networks where the individual computers were physically distributed within some geographical area. The term is nowadays used in a much wider sense, and often refers to autonomous processes that run within the same physical location and interact with each other by message passing.

A distributed system may have a common goal, such as solving a large computational problem. For example, in some distributed systems, the computational problem may be broken down into a plurality of smaller tasks that may be executed simultaneously or in parallel, and these tasks may be assigned to various computers of the distributed system. In such a system, the larger computational problem may be solved more quickly by leveraging the execution power of the distributed system to process the problem substantially in parallel, as opposed to a single computer processing the problem sequentially.

### SUMMARY

According to one general aspect, a method may include receiving a distributed application installation package. The distributed application installation package may include a distributed application installation file, a support program for the distribute application, and one or more configuration settings. The method may include installing at least the distributed application on a cluster of computing devices, such that the distributed application, when running, executes in a sandbox environment. The method may also include profiling a performance of the distributed application by executing, via the distribute application and within the sandbox environment on the cluster of computing devices, one or more tests. The method may further include generating a performance summary of the distributed application by collecting one or more pieces of profiled data generated during the execution of the one or more tests.

According to another general aspect, a system may include a user's computing device and a cluster of computing devices. The user's computing device may be configured to receive a distributed application installation package and install at least the distributed application on a master computing device, such that the distributed application is configured to execute in a sandbox environment. The distributed application installation package may include a distributed application installation file, and a support program for the distribute application. The cluster of computing devices may include the master computing device and at least one subservient computing device. The master computing device may be configured to install at least the distributed application on each of the subservient computing devices, such that the distributed application is configured to execute in a sandbox environment, manage an execution of one or more tasks by the distributed application, wherein each task executes via a respective computing device of the cluster of computing devices and within the sandbox environment associated with the respective computing device, automatically collect one or more pieces of profiled data generated during the execution of the one or more tasks, and generate a performance summary of the distributed application based upon the one or more pieces of profiled data.

According to another general aspect, an apparatus included in a cluster of computing devices may include a network interface and a processor. The network interface may be configured to transmit at least a distributed application to one or more subservient computing devices included by the cluster, wherein the distributed application is configured to execute in a sandbox environment. The processor may be configured to manage an execution of one or more tasks by the distributed application, wherein each task executes via a respective computing device of the cluster and within the sandbox environment associated with the respective computing device. The network interface may be configured to collect one or more pieces of profiled data generated during the execution of the one or more tasks. The processor may be configured to generate a performance summary of the distributed application based upon the one or more pieces of profiled data.

The details of one or more implementations are set forth in the accompanying drawings and the description below. Other features will be apparent from the description and drawings, and from the claims.

A system and/or method for distributed computing, and more specifically to the set-up and testing of a distributed application, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a flowchart of an example embodiment of a technique in accordance with the disclosed subject matter.

FIG. 3a is a graph of an example embodiment of a performance summary in accordance with the disclosed subject matter.

FIG. 3b is a graph of an example embodiment of a performance summary in accordance with the disclosed subject matter.

FIG. 4 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

In various embodiments, a distributed system may be difficult to create. Traditionally distributed programs or applications tend to be very complex and difficult to maintain. Further, the distributed application needs to be installed and configured not just once (as would be done with non-distributed applications that execute on a single machine) but multiple times. The distributed application may be installed and set-up or configured for each computing device in the distributed system. As such, a distributed system that includes 32 computing devices would require the distributed application to be installed and configured 32 times (once for each computing device).

Making this installation and maintenance task more complex are at least two additional issues. First, many distributed applications are not independent. Often they require supporting programs or are dependent upon various software libraries. For example, the Apache Hadoop distributed application, requires the Oracle Java RunTime Environment (JRE), and various software libraries thereof (e.g., the Jersey web service engine, the Apache Logging Service (Log4j), etc.). Likewise, all of these supporting programs or dependencies all be installed and set-up on each computing device. As such, the installation of a distributed application within a distributed system is often non-trivial. It is understood that the above are merely a few illustrative examples to which the disclosed subject matter is not limited.

Secondly, distributed systems are often non-homogeneous. Often the various computing devices within a distributed system may vary significantly. For example, some computing devices may execute the Microsoft Windows operating system (OS), whereas others may execute some version of the Linux OS, etc. In another example, the distributed system may all execute the same basic OS, but may execute different versions of it (e.g., Windows 7 & Windows 8.1, Linux 3.11 & 2.6, etc.). More often, the various computing devices may be comprised of differing hardware components (e.g., different amounts of memory, storage, processing power, etc.; a camera; a graphical processor; etc.). As such, when installing and configuring the distributed application, each computing device may require slightly different configuration settings, and or software, depending upon the capabilities of the respective computing device. In such an embodiment, often a uniform or one-size-fits-all installation routine may not be employed. In some embodiments, this issue may be ameliorated by having a homogeneous distributed system. However, such uniformity tends to be expensive (e.g., all computing devices be upgraded or replaced simultaneously, etc.) or otherwise inconvenient. It is understood that the above are merely a few illustrative examples to which the disclosed subject matter is not limited.

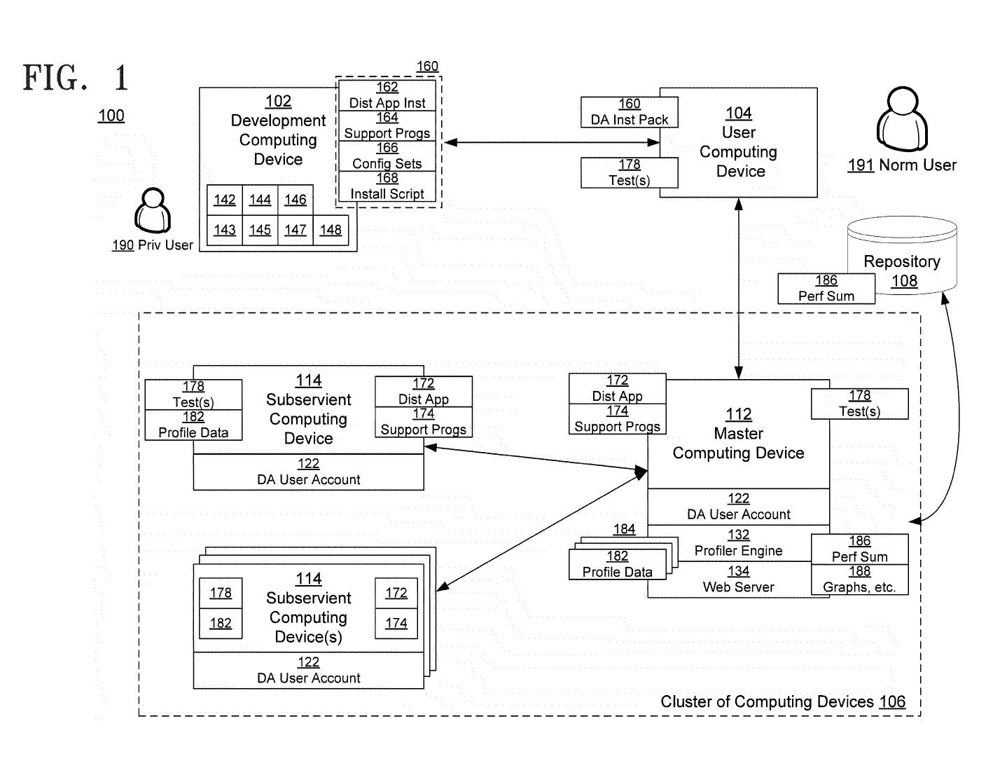

FIG. 1 is a block diagram of a system 100 for installing and testing a distributed application and any desired support programs/software packages. In various embodiments, the system 100 may be primarily contained within a single location (e.g., a laboratory, a data center, etc.). In another embodiment, the system 100 may be physically distributed across a number of geographic locations. It is understood that the above are merely a few illustrative examples to which the disclosed subject matter is not limited.

In various embodiments, the system 100 may include a user computing device 104, and a plurality or cluster of computing devices 106. In another embodiment, the system 100 may also include a development computing device 102. In some embodiments, the distributed application 172 may be installed and executed by a non-privileged or normal user 191. In such an embodiment, the normal user 191 may not have special privileges or rights to perform certain actions (e.g., an administrative user, a super user, etc.) on the cluster of computing devices 106. In various embodiments, the normal user 191 may be a privileged user in actuality, but such special privileges or rights may not be required to perform the actions described below.

In various embodiments, the plurality or cluster of computing devices 106 may include one or more computing devices (e.g., master computing device 112, subservient computing device(s) 114, etc.). In some embodiments, each of the cluster's computing devices may include a device, such as, for example, a laptop, desktop, workstation, system-on-a-chip (SoC), smartphone, tablet, and other appropriate computers, etc. or a virtual machine or virtual computing device thereof. In one embodiment, the cluster of computing devices 106 may be homogeneous, in that all of the computing devices are substantially identical. In another embodiment, the cluster of computing devices 106 may be heterogeneous, in that the computing devices differ in some non-trivial way from at least one other computing device within the cluster 106. It is understood that the above are merely a few illustrative examples to which the disclosed subject matter is not limited.

In some embodiments, the cluster of computing devices 106 may be exclusively dedicated to executing the distributed application 172 and any other tests or tasks related to the distributed application 172. In various other embodiments, one or more of the computing devices within the cluster 106 may perform other operations unrelated to the distributed application. For example, a subservient computing device 114, in one embodiment, may be the primary workstation for a user (not shown) and thus may execute the standard work applications used by that user (e.g., a word processor, a spreadsheet, an integrated design environment, etc.), and may also execute the distributed application 172. It is understood that the above is merely one illustrative example to which the disclosed subject matter is not limited.

In some embodiments, the cluster of computing devices 106 may be exist within a “real world” environment in which the computing devices are configured to operate while connected to broad network (e.g., the Internet, etc.) and make use of standard Internet protocols (e.g., a dynamic name server (DNS), etc.). In another embodiment, the cluster of computing devices 106 may be exist within an “idealized” or “segregated” environment (e.g., a laboratory, etc.). In such an embodiment, the cluster of computing devices 106 may have limited connectivity and may not use standard Internet protocols (e.g., network name discovery, such as DNS, may be disabled, etc.). It is understood that the above are merely a few illustrative examples to which the disclosed subject matter is not limited.

In the illustrated embodiment, a user 191 may wish to install or deploy a distributed application 172 (or a newer version thereof) to the cluster of computing devices 106 and test how well the distributed application 172 works with the given cluster 106. As described above, traditionally various issues or difficulties may arise when attempting to fulfill that desire.

In the illustrated embodiment, an administrative or privileged user 190 may create a distributed application installation package 160. In various embodiments, this distributed application installation package 160 may be used by the normal user 191 to install the distributed application 172 without the complexity traditionally associated with distributed application installation and configuration. In various embodiments, the creation of the distributed application installation package 160 may be done infrequently and may be reused for a number of clusters 106 or installations of the distributed application 172.

In various embodiments, the privileged user 190 may employ a development computing device 102. In some embodiments, the development computing device 102 may include a computing device, such as, for example, a laptop, desktop, workstation, personal digital assistant, smartphone, tablet, and other appropriate computers, etc. or a virtual machine or virtual computing device thereof. In various embodiments, the computing device 102 may include a processor 142 configured to execute one or more machine executable instructions or pieces of software, firmware, or a combination thereof. The computing device 102 may include, in some embodiments, a memory 144 configured to store one or more pieces of data, either temporarily, permanently, semi-permanently, or a combination thereof. Further, the memory 144 may include volatile memory, non-volatile memory or a combination thereof. In various embodiments, the computing device 102 may include a storage medium 145 configured to store data in a semi-permanent or substantially permanent form. In various embodiments, the storage medium 145 may be included by the memory 144.

In various embodiments, the computing device 102 may include one or more network interfaces 146 configured to allow the user device 102 to be part of and communicate via a communications network. Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

In various embodiments, the computing device 102 may include one or more other hardware components 143 (e.g., a display or monitor, a keyboard, a mouse, a camera, a fingerprint reader, a video processor, etc.). It is understood that the above are merely a few illustrative examples to which the disclosed subject matter is not limited.

In various embodiments, the computing device 102 may include an operating system (OS) 147 configured to provide one or more services to an application 148 (e.g., an integrated design environment, a text editor, etc.) and manage or act as an intermediary between the application 148 and the various hardware components (e.g., the processor 142, a network interface 146, etc.) of the computing device 102. In such an embodiment, the computing device 102 may include one or more native applications, which may be installed locally (e.g., within the storage medium 145, etc.) and configured to be executed directly by the processor 142 and directly interact with the OS 147. In such an embodiment, the native applications may include pre-compiled machine executable code. In some embodiments, the native applications may include a script interpreter (e.g., C shell (csh), AppleScript, AutoHotkey, Python etc.) or a virtual execution machine (VM) (e.g., the Java Virtual Machine, the Microsoft Common Language Runtime, etc.) that are configured to translate source or object code into executable code which is then executed by the processor 142.

In the illustrated embodiment, the privileged user 190 may acquire or download the distributed application installation file 162 (or files), and any required or desired support programs 164 or dependent software libraries. For example, returning to the Hadoop example (to which the disclosed subject matter is not limited), the distributed application installation file 162 may include downloading the Hadoop TAR (tape archive) file from the Hadoop web page. This may also include downloading the Java Runtime Environment (JRE) installation file from the Java web page, and downloading any needed or desired libraries (e.g., the Jersey web service engine, the Apache Logging Service (Log4j), etc.). In various embodiments, multiple versions of the files 162 and 164 may be acquired and subsequently included in the distributed application installation package 160, as described below.

In various embodiments, the privileged user 190 may write or edit one or more configuration settings files or information 166. In various embodiments, these configuration settings 166 may modify the behavior of the distributed application 172 or support programs 174. In some embodiments, the configuration settings 166 may include a plurality of different configuration sets. In such an embodiment, each configuration set may be associated with a different type of computing device within the cluster 106 or even a different type of cluster 106, as the distributed application installation package 160 may be used with more than one cluster 106. In some embodiments, the configuration settings may include one or more default configuration settings or groups of settings in case a specific computing device is not an ideal match for any of the predefined possible configuration sets. It is understood that the above are merely a few illustrative examples to which the disclosed subject matter is not limited.

The privileged user 190 may then write an installation script 168 or program that provides instructions to a computing device (e.g., master computing device 112, etc.) on how to automatically install the distributed application 172 and support programs and/or libraries 174 without the need for human intervention. In some embodiments, the installation script 168 may be dynamically adaptive, such that it is configured to perform different functions depending upon the computing device that it is targeting or being executed upon. For example, if the cluster 106 is not homogeneous, the installation script 168 may install different files or a different set of configuration settings depending upon the respective computing device. As a specific example, if a first subservient computing device 114 is executing the Windows OS, the installation script 168 may detect this and dictate that the Windows version of the distributed application 172 or support programs 174 be installed. Whereas, if a second subservient computing device 114 is executing the Linux OS, the installation script 168 may detect this and dictate that the Linux version of the distributed application 172 or support programs 174 be installed. In such an embodiment, the distributed application installation package 160 may include different versions of the various files, as described above. In another embodiment, the installation script 168 may be configured to query the computing device and determine the system resources provided by the computing device (e.g., type of processor, amount of memory, OS, etc.) and dynamically select a given set of configuration settings based upon the system resources of the respective computing device. It is understood that the above are merely a few illustrative examples to which the disclosed subject matter is not limited.

In various embodiments, the installation script 168 may include a pre-compiled application or an application that is interpreted by another application (e.g., the OS, a runtime interpreter, etc.). In the illustrated embodiment, the installation script 168 may include a number of scripts written in a plurality of programming languages (e.g. Python, bash, etc.). In such an embodiment, the distributed application installation package 160 may be deployed across a wide range of architectures and types of clusters 106. It is understood that the above is merely one illustrative example to which the disclosed subject matter is not limited.

In various embodiments, the privileged user 190 may aggregate the distributed application installation file 162, any support programs or libraries 164, configuration settings or information 166, and the installation script 168 into a unified distributed application installation package 160. The privileged user 190 may test that the distributed application installation package 160 works as desired (i.e. it installs the distributed application 172, et al.) and may then release the distributed application installation package 160 for use by a normal user 191.

In the illustrated embodiment, the distributed application installation package 160 is shown as a single file that includes all the desired or possible components. In various embodiments, this file may be a TAR file, a ZIP file, etc. In another embodiment, the install script 168 may be configured to dynamically select and download files (e.g., the distributed application install file 162, configuration settings 168, etc.) from a server (e.g., the development computing device 102, etc.). However, this may be less desirable than the illustrated aggregated file as such dynamic acquisition of the install files would require the cluster 106 to have access to the hosting server. This access may not exist if the cluster 106 is operating in an isolated environment (e.g., a laboratory, etc.). It is understood that the above are merely a few illustrative examples to which the disclosed subject matter is not limited.

As described above, in the illustrated embodiment, a normal, non-privileged user 191 may desire to install the distributed application 172 across a cluster 160. In the illustrated embodiment, the normal user 191 may make use of a user computing device 104. In some embodiments, the user computing device 104 may include a computing device, such as, for example, a laptop, desktop, workstation, system-on-a-chip (SoC), personal digital assistant, smartphone, tablet, and other appropriate computers, etc. or a virtual machine or virtual computing device thereof. Further, in various embodiments, the user computing device 104 may include one or more components similar or analogous to the components of the development computing device 102 (e.g., processor 142, memory 144, network interface 146, operating system 147, etc.).

In various embodiments, the normal, non-privileged user 191 may receive the distributed application installation package 160. For example, the privileged user 190 may work in an information technology group of a company and send the distributed application installation package 160 out to various research and development groups within the company. The normal user 191 may work in one of those groups. Alternately, the distributed application installation package 160 may come from a third party or external company. It is understood that the above are merely a few illustrative examples to which the disclosed subject matter is not limited.

The normal user 191 may be in charge of or associated with a given cluster of computing devices 106. In the illustrated embodiment, the cluster 106 may include a master computing device 112 and one or more subservient computing device 114. In some embodiments, the master computing device 104 and/or subservient computing devices may each include a computing device, such as, for example, a laptop, desktop, workstation, system-on-a-chip (SoC), smartphone, tablet, and other appropriate computers, etc. or a virtual machine or virtual computing device thereof. Further, in various embodiments, the computing device 112 and/or 114 may include one or more components similar or analogous to the components of the development computing device 102 (e.g., processor 142, memory 144, network interface 146, operating system 147, etc.). As described above, the cluster 106 may be heterogeneous or homogeneous depending upon the embodiment.

In the illustrated embodiment, the user 191 may install the distributed application 172, and any support programs or libraries 174 onto the master computing device 112. In various embodiments, the master computing device 112 may be predetermined. In another embodiment, the user 191 may select which of the cluster's computing devices is to become the master computing device 112. In such an embodiment, because the distributed application installation package 160 is pre-packaged and configured to automatically install the distributed application 172, et al. with little or no inaction by the user 191, the user 191 not need to be technically savvy as the distributed application installation package 160 may automatically perform optimizations and best guesses on behalf of the user 191 (e.g., distributed application settings (e.g., number of containers, timeouts, etc.), file system mounting options, etc. It is understood that the above is merely one illustrative example to which the disclosed subject matter is not limited.

In the illustrated embodiment, the distributed application installation package 160 may be configured to install the distributed application 172, et al. within a sandbox environment. In such an embodiment, the sandbox environment may be effectively isolated from other possible users of the cluster 106 or computing device 112. In such an embodiment, the sandbox may allow the distributed application 172 to be executed without affecting any other executing applications (e.g., the web server 134, a word processor, etc.), aside from the consumption of system resources (e.g., processing cycles, portions of memory, etc.). In such an embodiment, this sandbox may allow the distributed application 172 to be installed or removed without affecting other installed applications or programs.

In one embodiment, the sandbox environment may include the creation of a separate and dedicated user account 122. In some embodiments, the distributed application (DA) user account 122 may include privileges, group associations, etc. that differ from the account of the normal user 191. In various embodiments, the distributed application 172, et al. may be installed as belonging to or associated with the DA user account 122. In such an embodiment, this may be used to identify or mark which files and/or settings are associated with the distributed application 172 et al. and allow for simpler modification and/or removal. In some embodiments, when the distributed application 172 is executed, it may be executed by the DA user account 122 and not the normal user 191's account. In such an embodiment, the execution of the distributed application 172 may take advantage, or be limited to the privileges associated with the DA user account 122 and not that of the normal user 191. In some embodiments, this may allow any user to run or execute the distributed application 172.

Once the distributed application 172 et al. has been installed upon the master computing device 112, the master computing device 112 may then deploy or install the distributed application 172 et al. upon the subservient computing devices 114. In various embodiments, this may involve the distributed application installation package 160. In some embodiments, this installation or deployment to a plurality of subservient computing devices 114 may occur substantially in parallel, or in a staged form of parallelism. In various embodiments, this installation may include the creation, upon the subservient computing devices 114, of a DA user account 122 substantially identical to that on the master computing device 112. As described above, the distributed application 172, et al. may be installed or deployed within a sandboxed environment.

In various embodiments, the configuration settings 166 within the distributed application installation package 160 may allow for the distributed application 172, et al. to be installed within a cluster 106 that is at least semi-connected or managed (e.g., via dynamic name server, Dynamic Host Configuration Protocol (DHCP), etc.), or within an isolated network that does not employ external network configuration. In such an embodiment, the distributed application installation package 160 may be configured to discover the various computing devices of the cluster 106 and configure them to communicate amongst themselves. In various embodiments, the various configuration settings 166 may allow for a dynamic configuration of the various computing devices 112 and/or 114, as described above.

In the illustrated embodiment, once the master computing device 112 has installed the distributed application 172, et al. upon the desired subservient computing devices 114, the master computing device 112 or the user computing device 104 may check that the installation was successful. In one embodiment, this may include examining one or more log files or other messages received during the installation process. If those log files or messages are not ideal, the configuration settings may be adjusted or installation may be re-attempted using an alternate form of the distributed application 172, et al. (e.g., a support program 174 tailored to a different version of the computing device's operating system, etc.).

In one embodiment, the master computing device 112 or the user computing device 104 may execute one or more small, predetermined, “heartbeat” tests using the distributed application 172. In such an embodiment, the purpose of the small tests may simply be to determine if the distributed application 172 has a basic level of functionality on all the installed computing devices 112 and 114. In various embodiments, if either the installation logs, messages, or the results of the small, “heartbeat” tests are undesirable, remedial action may be taken. In some embodiments, a remedial action may include removing a failed subservient computing device 114 from the cluster 106 (e.g., by removing the distributed application 172, et al., etc.) or having either normal user 191 or privileged user 190 take a more proactive action. It is understood that the above are merely a few illustrative examples to which the disclosed subject matter is not limited.

Once the distributed application 172, et al. has been properly installed across the cluster 106, the normal user 191 may wish to profile or test the performance of the cluster 106. In the illustrated embodiment, the normal user 191 may have one or more tests 178 designed to execute via the distributed application 172. In such an embodiment, the tests 178 may stress or exercise the cluster 106 in various ways (e.g., heavy processing cycle usage, allocation of many small test 178 amongst the cluster's computing devices, bandwidth usage, etc.). In various embodiments, the tests 178 may be configured to monitor and record various system resources of the respective computing devices 112 or 114 used to execute the tests 178. This recorded data may be referred to as profile data 182. In various embodiments, these profiling functions may be part of the test 178, the distributed application 172, and/or one or more support programs 174. It is understood that the above are merely a few illustrative examples to which the disclosed subject matter is not limited.

In the illustrated embodiment, the normal user 191 may select one or more tests 178 or group of tests to be executed by the distributed application 172. In various embodiments, the normal user 191 may be presented with a predefined set of tests or a number of pre-defined sets that respectively test or exercise different aspects of the cluster 106 and the distributed application's possible performance. In some embodiments, these tests 178 may be created and distributed by the privileged user 190 or similar user. In another embodiment, tests 178 may be generated by the normal user 191. It is understood that the above are merely a few illustrative examples to which the disclosed subject matter is not limited.

In the illustrated embodiment, the normal user 191 may cause these tests 178 to be executed by the distributed application 172. In due course, the distributed application 172 may allocate the various tests 178 amongst the computing devices 112 and 114 of the cluster 106. Once allocated, the local instantiation of the distributed application 178 may execute or perform the allocated test 178 and record the results in the profile data 182. In time, the tests 178 may all complete. In some embodiments, one or more tests 178 may fail to complete successfully and the distributed application 172 may perform a remedial action as dictated by its configuration settings or an action defined in the tests 178 (e.g., restart the failed test, re-allocate the failed test to another computing device 114, report the failure, etc.). It is understood that the above are merely a few illustrative examples to which the disclosed subject matter is not limited. As described above, in various embodiments, the distributed application 172 may execute these tests 178 within the sandbox environment and using the DA user account 122.

In the illustrated embodiment, once the test 178 have completed, the master computing device 112 may gather the distributed pieces of profile data 182 together. In various embodiments, the master computing device 112 may include or have installed upon it a profiler engine 132. In some embodiments, the profiler engine 132 may be included within the support programs 174 and/or the support program installation files 164. In various embodiments, the profiler engine 132 may be installed upon the master computing device 112 but not the various subservient computing device 114. It is understood that the above is merely one illustrative example to which the disclosed subject matter is not limited.

In the illustrated embodiment, the profiler engine 132 may be configured to collect the disparate pieces of profile data 182 from the various subservient computing devices 114. In such an embodiment, the profiler engine 132 may also be configured to aggregate the profile data 182 into a unified profile data 184 that represents the collected profile data from the entire cluster 106 and not just individual computing devices 112 and/or 114.

As described above, the profile data 182 and the unified profile data 184 may include measurements of various system resources. For example, the profile data 182 may include a measure of the processor usage, memory usage, storage medium usage, network usage, performance data of a runtime environment (e.g., the size of the Java Runtime heap, etc.), the time to completion of each individual test 178, the time to completion of tests 178 as a whole, etc. The profile data 182 and unified profile data 184 may also include information regarding a test 178 that may have failed or generally completion results of the tests 178. In yet another embodiment, the profile data 182 and unified profile data 184 may also include logs generated during the execution of the tests 178. It is understood that the above are merely a few illustrative examples to which the disclosed subject matter is not limited.

In the illustrated embodiment, the profiler engine 132 may be configured to automatically generate a performance summary 186 of the distributed application based upon the unified profile data 184, or a portion thereof. In various embodiments, the performance summary 186 may include one or more plots, diagrams, and/or graphs 188. In such an embodiment, the generation of the graphs 188 may result in the creation and storage of graphics files (e.g., a JPEG file, a Portable Network graphics (PNG) file, etc.). The raw data from the unified profile data 184 may be reformatted into a more desirable format (e.g., comma separated values (CSV) spreadsheet, a table, a data file, etc.). It is understood that the above are merely a few illustrative examples to which the disclosed subject matter is not limited.

In one embodiment, the performance summary 186 may include a measure of the real-time or wall-clock time it took to complete the tests 178, and the throughput of the distributed application 172 during the execution of the tests 178. In another embodiment, the performance summary 186 may include an analysis of the performance of each computing device 112 and/or 114. In such an embodiment, the cluster 106 may be checked to determine any bottlenecks or weak performers in cluster 106. In various embodiments, the performance summary 186 may include data correlated by time (actual or computer cycles, etc.), computing device 112 and 114, test 178, a groups or categories of such smaller, more granular forms of analysis. It is understood that the above are merely a few illustrative examples to which the disclosed subject matter is not limited.

In various embodiments, the master computing device 112 may include or have installed upon it a web server 134 or other application that facilitates the accessing of the performance summary 186 and/or unified profile data 184 (e.g., file transfer protocol (FTP) server, database server, etc.). In some embodiments, the web server 134 may be included within the support programs 174 and/or the support program installation files 164. In various embodiments, the web server 134 may be installed upon the master computing device 112 but not the various subservient computing device 114. It is understood that the above is merely one illustrative example to which the disclosed subject matter is not limited.

In the illustrated embodiment, the normal user 191 (or other interested party) may be able to access the performance summary 186 via the web server 134. In such an embodiment, the performance summary 186 may be formatted by either the profiler engine 132 or the web server 134 into a desired format (e.g., hypertext markup language (HTML), etc.), and made available via the traditional scheme according to the protocol employed by the web server 134. In various embodiments, the web server 134 may include a security mechanism (e.g., password protection, encryption, etc.). In various embodiments, the web server 134 and/or the profiler engine 132 may be executed using the DA user account 122 and within the sandbox environment, as described above.

In various embodiments, the unified profile data 182 and/or the performance summary 186 may be stored within a repository 108. In various embodiments, the repository 108 may include a computing device similar to those described above.

In the illustrated embodiment, a plurality of performance summaries 186 (and sets of unified profile data 184) may be stored within the repository 108. In such an embodiment, a user (e.g., normal user 191, etc.) may retrieve these prior performance summaries 186 and view how the distributed application 172 and/or cluster 106 performed as a function of time or other variables (e.g. tests executed, the computing devices 112 and 114 that were included in the cluster 106, etc.). In such an embodiment, the performance of the system 100 may even be compared and contrasted against other embodiments of the system (e.g., a cluster in a different laboratory, a cluster that executes a different OS, a cluster that is not isolated from the Internet, etc.). It is understood that the above are merely a few illustrative examples to which the disclosed subject matter is not limited.

In the illustrated embodiment, once the distributed application 172, et al. are installed, the user 191 may run or execute any number of tests 178 or other more generally tasks. In such an embodiment, the distributed application 172 may be employed to perform non-profiling tasks if desired. Again, these tasks may be executed within the sandbox environment described above.

At some point, the user 191 may wish to uninstall the distributed application 172, et al. In such an embodiment, the distributed application installation package 160 or similar may include an uninstaller program or script. In various embodiments, this uninstaller script may be part of the installer script 168.

In such an embodiment, the process for uninstallation may substantially mirror that of installation. The user 191 may instruct the master computing device 112 to uninstall the distributed application 172 et al. from the cluster 106. The master computing device 112 may supervise the uninstallation of the distributed application 172 et al. from the various subservient computing devices 114, and then may uninstall the distributed application 172 et al. from the master computing device 112 itself, and report success or failure back to the user 191.

In the illustrated embodiment, because the distributed application 172 et al. was installed in a sandbox environment, once the uninstallation is completed there may be little or no trace of the distributed application 172 et al. within the cluster 106. Specifically the distributed application 172, and support programs 174 may be removed. Any tests 178, profile data 182 or 184, and performance summaries 186 may be removed. In addition, the profiler engine 132 and web server 134 may be removed. Likewise, the DA user account 122 may be deleted or removed. In such an embodiment, as the DA user account 112 and the distributed application 172 et al. were partitioned or isolated from any other users of the computing devices 112 and 114, the distributed application 172 et al. may be installed or uninstalled without needing for the operating system to be rebooted or the other users to be affected. In various embodiments, uninstallation may result in the cluster 106 returning to the same state it was in prior to the installation of the distributed application 172 et al. It is understood that the above are merely a few illustrative examples to which the disclosed subject matter is not limited.

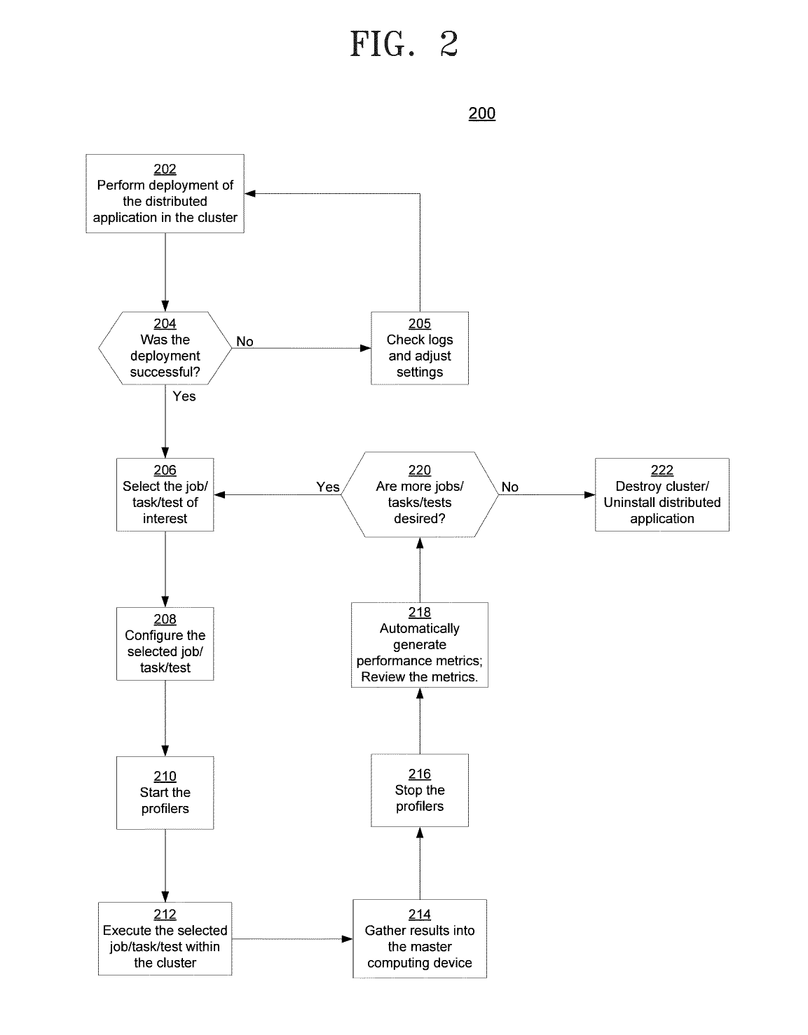

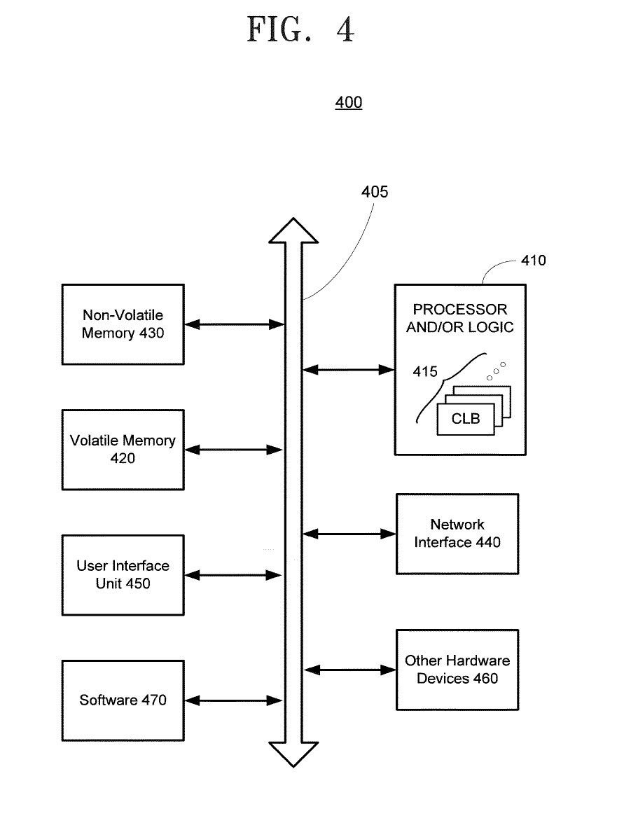

FIG. 2 is a flow chart of an example embodiment of a technique in accordance with the disclosed subject matter. In various embodiments, the technique 200 may be used or produced by the systems such as those of FIG. 1 or 4. Furthermore, portions of technique 200 may be used or produced by the systems such as that of FIG. 1. Although, it is understood that the above are merely a few illustrative examples to which the disclosed subject matter is not limited. It is understood that the disclosed subject matter is not limited to the ordering of or number of actions illustrated by technique 200.

Block 202 illustrates that, in one embodiment, the deployment or installation of the distributed application may occur within the cluster, as described above. In various embodiments, this may occur via a distributed application installation package, As described above, In some embodiments, this may occur by installing the distributed application on a master computing device of the cluster, and then installing it on one or more subservient computing devices. In various embodiments, one or more of the action(s) illustrated by this Block may be performed by the apparatuses or systems of FIG. 1; or the user computing device, the cluster, master computing device, and/or subservient computing devices of FIG. 1, as described above.

Block 204 illustrates that, in one embodiment, one or more tests may be performed that determine if the distributed application was successfully deployed, as described above. Block 205 illustrates that, in one embodiment, if the distributed application was not successfully deployed, log files may be examined or checked and then deployment may be re-attempted (in whole or part) using a different or an adjusted set of configuration settings, as described above. In various embodiments, this may occur automatically, as described above. In various embodiments, one or more of the action(s) illustrated by these Blocks may be performed by the apparatuses or systems of FIG. 1; or the user computing device, the cluster, master computing device, and/or subservient computing devices of FIG. 1, as described above.

Block 206 illustrates that, in one embodiment, a user (e.g., a non-privileged or normal user, etc.) may select a job, task, or test to be performed or executed by the distributed application, as described above. Block 208 illustrates that, in one embodiment, the selected tests may be configured if needed or desired. In various embodiments, some or all of these configurations may occur automatically. In another embodiment, the user may manually configure or establish the settings associated with selected tests. In various embodiments, one or more of the action(s) illustrated by these Blocks may be performed by the apparatuses or systems of FIG. 1; or the user computing device, the cluster, master computing device, and/or subservient computing devices of FIG. 1, as described above.

Block 210 illustrates that, in one embodiment, prior to executing the selected tests or as part of executing the selected tests, one or more profilers may be initialized and started. As described above, the profilers may monitor and record various system resource usage. In various embodiments, one or more of the action(s) illustrated by this Block may be performed by the apparatuses or systems of FIG. 1; or the profiler engine, support programs, distributed application, the cluster, master computing device, and/or subservient computing devices of FIG. 1, as described above.

Block 212 illustrates that, in one embodiment, the distributed application may execute the selected tests, as described above. In various embodiments, the distributed application may monitor and record various system resource usage, as described above. In various embodiments, one or more of the action(s) illustrated by this Block may be performed by the apparatuses or systems of FIG. 1; or the profiler engine, support programs, distributed application, the cluster, master computing device, and/or subservient computing devices of FIG. 1, as described above.

Block 214 illustrates that, in one embodiment, once the distributed application has completed the execution of the tests (either in whole or in part), the results or profiling data may be collected or gathered to the master computing device, as described above. Block 216 illustrates that, in one embodiment, once the profile data has been collected, the profilers may be stopped. In various embodiments, one or more of the action(s) illustrated by these Blocks may be performed by the apparatuses or systems of FIG. 1; or the profiler engine, support programs, distributed application, the cluster, master computing device, and/or subservient computing devices of FIG. 1, as described above.

Block 218 illustrates that, in one embodiment, performance metrics and/or graphs, etc. may be automatically generated based upon the collected profile data, as described above. In various embodiments, these generated performance metrics may be reviewed by a user, as described above. In some embodiments, the performance metrics may be made available via a web server or other server application, as described above. In various embodiments, one or more of the action(s) illustrated by this Block may be performed by the apparatuses or systems of FIG. 1; or the profiler engine, web server, distributed application, and/or the cluster, master computing device of FIG. 1, as described above.

Block 220 illustrates that, in one embodiment, a determination may be made by the user as to whether it is desirable to execute more jobs, tasks, or tests via the distributed application. If so, Block 206 illustrates that the new set of jobs, tasks, or tests may be executed via the distributed application, as described above.

Block 222 illustrates that, in one embodiment, the distributed application and associated files may be uninstalled or removed from the cluster, as described above. In some embodiments, this may be considered as destroying the cluster. In such an embodiment, the cluster may be considered an ad hoc grouping of computing devices defined by their association with the distributed cluster. In various embodiments, one or more of the action(s) illustrated by this Block may be performed by the apparatuses or systems of FIG. 1; or the distributed application installation package, and/or the cluster, master computing device, subservient computing device, and/or user computing device of FIG. 1, as described above.

In various embodiments, the actions of Blocks 206, 208, 220, and part of 218 may be performed or initiated by the user. In various embodiments, the other Blocks may be performed automatically by the system, as described above. In some other embodiments, one or more of the actions of Blocks 206, 208, 220, and part of 218 may also be automated. It is understood that the above are merely a few illustrative examples to which the disclosed subject matter is not limited.

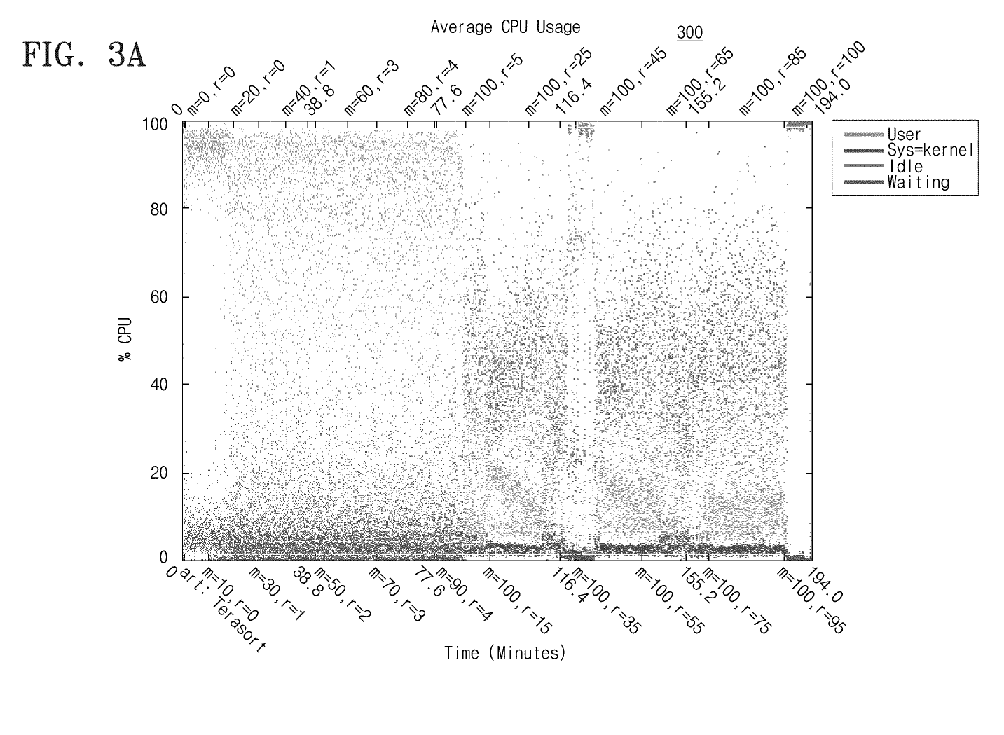

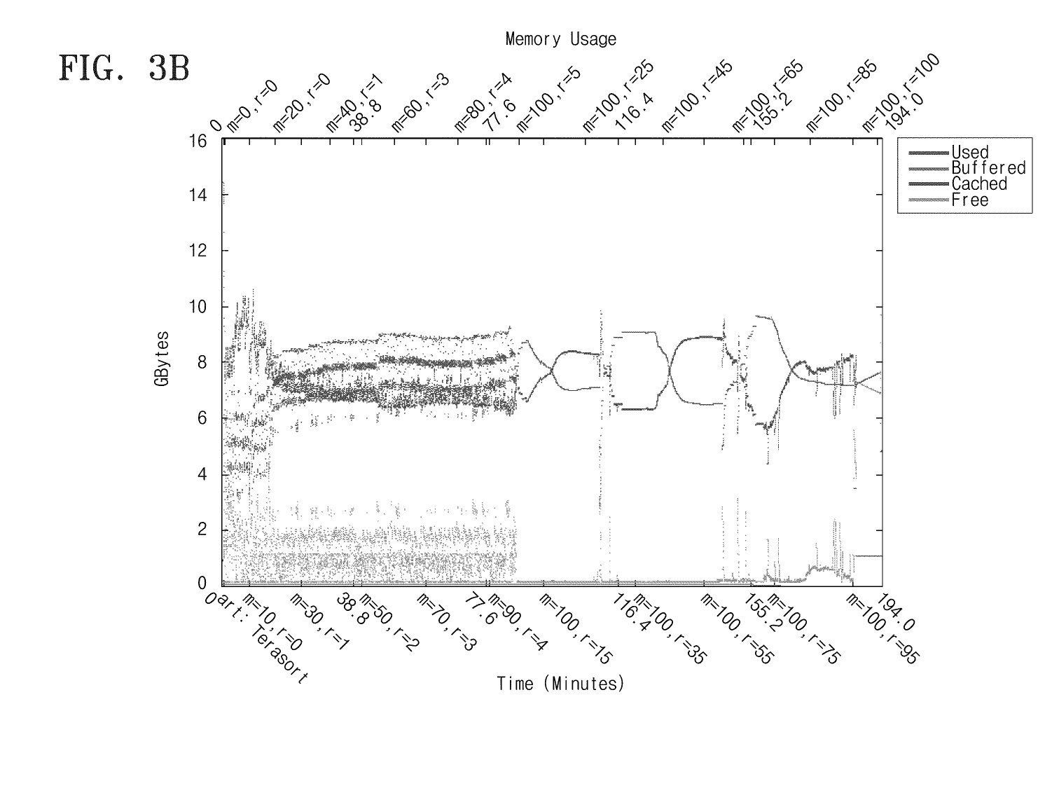

FIG. 3a is a graph of an example embodiment of a performance summary 300 in accordance with the disclosed subject matter. In the illustrated embodiment, the performance summary 300 includes a graphical representation of the average processor or central processor unit (CPU) usage as a function of time.

As described above, in various embodiments, the system may automatically generate a performance summary of the distributed application based upon the collected data or unified profile data, or a portion thereof. As described above, in some embodiments, the performance summary may include one or more plots, diagrams, and/or graphs.

In the illustrated embodiment, the graph 300 may include a performance summary or a portion thereof. In such an embodiment, as the distributed application executes over time, the amount of the CPU usage may be measured for each of the computing devices within the cluster.

In some embodiments, the computing devices may be grouped based upon a predefined set of criteria. For example, the CPUs may be grouped by their architecture (e.g., x86, ARM, etc.), by task type, location, etc. It is understood that the above are merely a few illustrative examples to which the disclosed subject matter is not limited. In various embodiments, the graph 300 may include a number of colors (not shown in the black and white figure) or other form of identification that allow a user to comprehend quickly the data collected. It is understood that the above is merely one illustrative example to which the disclosed subject matter is not limited.

FIG. 3b is a graph of an example embodiment of a performance summary 301 in accordance with the disclosed subject matter. In the illustrated embodiment, the performance summary 301 includes a graphical representation of the memory usage as a function of time.

As described above, in various embodiments, the system may automatically generate a performance summary of the distributed application based upon the collected data or unified profile data, or a portion thereof. As described above, in some embodiments, the performance summary may include one or more plots, diagrams, and/or graphs.

In the illustrated embodiment, the graph 301 may include a performance summary or a portion thereof. In such an embodiment, as the distributed application executes over time, the amount of memory usage may be measured for each of the computing devices within the cluster.

As described above, in some embodiments, the computing devices may be grouped based upon a predefined set of criteria, for example, by task type, location, etc. In another embodiment, the graph may include information regarding how the memory is employed. For example, in the illustrated embodiment, the graph 301 may include four lines or data sets that indicate the percentage of the memory that is free, cached, buffered, or used. It is understood that the above is merely one illustrative example to which the disclosed subject matter is not limited.

As described above, in various embodiments, the graph 300 may include a number of colors (not shown in the black and white figure) or other form of identification that allow a user to quickly comprehend the data collected. It is understood that the above is merely one illustrative example to which the disclosed subject matter is not limited.

In various embodiments, other forms of graphically represented data may include a comparison of CPU usage versus input/output throughput, a comparison of bandwidth throughput versus time, a comparison of input/output delay or wait per CPU core versus time, a comparison of kernel usage versus time, a comparison of network usage or congestion versus time, a comparison of interrupts or error conditions versus time, etc. It is understood that the above are merely a few illustrative examples to which the disclosed subject matter is not limited. In another embodiment, the graphically data may represent three or more variables within a single graph. For example, a single graph may include a three-dimensional graph that compares the amount of memory used, the amount of disk usage (e.g., number of read/write requests), and the amount of network usage against each other. It is understood that the above is merely one illustrative example to which the disclosed subject matter is not limited.

FIG. 4 is a schematic block diagram of an information processing system 400, which may include semiconductor devices formed according to principles of the disclosed subject matter.

Referring to FIG. 4, an information processing system 400 may include one or more of devices constructed according to the principles of the disclosed subject matter. In another embodiment, the information processing system 400 may employ or execute one or more techniques according to the principles of the disclosed subject matter.

In various embodiments, the information processing system 400 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 400 may be used by a user (not shown).

The information processing system 400 according to the disclosed subject matter may further include a central processing unit (CPU), logic, or processor 410. In some embodiments, the processor 410 may include one or more functional unit blocks (FUBs) or combinational logic blocks (CLBs) 415. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 400 according to the disclosed subject matter may further include a volatile memory 420 (e.g., a Random Access Memory (RAM), etc.). The information processing system 400 according to the disclosed subject matter may further include a non-volatile memory 430 (e.g., a hard drive, an optical memory, a NAND or Flash memory, etc.). In some embodiments, either the volatile memory 420, the non-volatile memory 430, or a combination or portions thereof may be referred to as a “storage medium”. In various embodiments, the volatile memory 420 and/or the non-volatile memory 430 may be configured to store data in a semi-permanent or substantially permanent form.

In various embodiments, the information processing system 400 may include one or more network interfaces 440 configured to allow the information processing system 400 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 400 according to the disclosed subject matter may further include a user interface unit 450 (e.g., a display adapter, a haptic interface, a human interface device, etc.). In various embodiments, this user interface unit 450 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 400 may include one or more other devices or hardware components 460 (e.g., a display or monitor, a keyboard, a mouse, a camera, a fingerprint reader, a video processor, etc.). It is understood that the above are merely a few illustrative examples to which the disclosed subject matter is not limited.

The information processing system 400 according to the disclosed subject matter may further include one or more system buses 405. In such an embodiment, the system bus 405 may be configured to communicatively couple the processor 410, the volatile memory 420, the non-volatile memory 430, the network interface 440, the user interface unit 450, and one or more hardware components 460. Data processed by the processor 410 or data inputted from outside of the non-volatile memory 430 may be stored in either the non-volatile memory 430 or the volatile memory 420.

In various embodiments, the information processing system 400 may include or execute one or more software components 470. In some embodiments, the software components 470 may include an operating system (OS) and/or an application. In some embodiments, the OS may be configured to provide one or more services to an application and manage or act as an intermediary between the application and the various hardware components (e.g., the processor 410, a network interface 440, etc.) of the information processing system 400. In such an embodiment, the information processing system 400 may include one or more native applications, which may be installed locally (e.g., within the non-volatile memory 430, etc.) and configured to be executed directly by the processor 410 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 410.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SS OP) technique, a thin small outline package (TS OP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A method comprising:
receiving a distributed application installation package, wherein the distributed application installation package comprises a distributed application installation file, a support program for the distribute application, and one or more configuration settings;
installing at least the distributed application on a cluster of computing devices, such that the distributed application, when running, executes in a sandbox environment;
profiling a performance of the distributed application by executing, via the distribute application and within the sandbox environment on the cluster of computing devices, one or more tests; and
generating a performance summary of the distributed application by collecting one or more pieces of profiled data generated during the execution of the one or more tests.

2. The method of claim 1 wherein installing comprises creating a user account exclusively associated with the distributed application.

3. The method of claim 1 wherein the cluster of computing devices, when running, operates without employing a dynamic name server; and
wherein installing comprises:
discovering the computing devices within the cluster of computing devices, and
configuring the computing devices to communicate without the assistance of the dynamic name server.

4. The method of claim 1 wherein installing comprises:
installing the distributed application upon a master computing device of the cluster of computing devices; and
employing the master computing device to install the distributed application upon one or more other computing devices within the cluster of computing devices.

5. The method of claim 1 wherein profiling comprises:
distributing the one or more tests amongst the computing devices; and
executing the one or more tests by the respective computing devices employing a user account exclusively associated with the distributed application.

6. The method of claim 1 wherein generating comprises:
automatically collecting one or more pieces of profiled data generated during the execution of the one or more tests from the respective computing devices;
aggregating the one or more pieces of profiled data into a unified profiled data; and
generating one or more graphs visually representing at least a portion of the unified profiled data.

7. The method of claim 6 wherein generating comprises:
executing a web server on a master computing device of the cluster of computing devices; and
providing the one or more graphs via the web server.

8. The method of claim 1 wherein installing comprises verifying an integrity of the distributed application by executing, on each computing device of the cluster, one or more predefined tests that verify a predetermined aspect of the distributed application.

9. The method of claim 1 wherein installing comprises:
isolating the distributed application from other possible users of the computing devices; and
installing the distributed application such that the distributed application may be removed from the computing devices without leaving a trace of the distributed application.

10. A system comprising:
a user's computing device configured to:
receive a distributed application installation package, wherein the distributed application installation package comprises a distributed application installation file, and a support program for the distribute application, and
install at least the distributed application on a master computing device, such that the distributed application is configured to execute in a sandbox environment; and
a cluster of computing devices comprising the master computing device and at least one subservient computing device, wherein the master computing device is configured to:
install at least the distributed application on each of the subservient computing devices, such that the distributed application is configured to execute in a sandbox environment,
manage an execution of one or more tasks by the distributed application, wherein each task executes via a respective computing device of the cluster of computing devices and within the sandbox environment associated with the respective computing device,
automatically collect one or more pieces of profiled data generated during the execution of the one or more tasks, and
generate a performance summary of the distributed application based upon the one or more pieces of profiled data.

11. The system of claim 10 wherein the master computing device is configured to, during installation of the distributed application, create a user account exclusively associated with the distributed application.

12. The system of claim 10 wherein the cluster of computing devices is isolated from the Internet; and
the master computing device is configured to, during the installation of the distributed application onto the subservient computing devices:
discover the subservient computing devices, and
configure the subservient computing devices to communicate without the assistance of a dynamic name server.

13. The system of claim 10, wherein the master computing device is configured to:
distribute the one or more tasks amongst the computing devices of the cluster; and
cause the one or more tasks to be executed by the respective computing devices using a user account exclusively associated with the distributed application.

14. The system of claim 10 wherein the master computing device is configured to:
automatically collect, from the subservient computing devices, one or more pieces of profiled data generated during the execution of the one or more tasks;
aggregate the one or more pieces of profiled data into a unified profiled data; and
generate one or more graphs visually representing at least a portion of the unified profiled data.

15. The system of claim 10 wherein the master computing device is configured to:
execute a web server that provides at least a portion of the performance summary to a user.

16. The system of claim 10 wherein the master computing device is configured to:
verify a correct installation of the distributed application within the cluster of computing devices by executing one or more tests that verify at least one predetermined aspect of the distributed application.

17. The system of claim 10 wherein he master computing device is configured to:
remove the distributed application from any subservient computing devices upon which the distributed application is installed, such that no trace of the distributed application remains after removal.

18. An apparatus included in a cluster of computing devices, the apparatus comprising:
a network interface configured to:
transmit at least a distributed application to one or more subservient computing devices included by the cluster, wherein the distributed application is configured to execute in a sandbox environment; and
a processor configured to:
manage an execution of one or more tasks by the distributed application, wherein each task executes via a respective computing device of the cluster and within the sandbox environment associated with the respective computing device;
wherein the network interface is configured to collect one or more pieces of profiled data generated during the execution of the one or more tasks; and
wherein the processor is configured to generate a performance summary of the distributed application based upon the one or more pieces of profiled data.

19. The apparatus of claim 18, wherein the apparatus is configured to:
cause the installation of the distributed application upon each of the one or more subservient computing devices, wherein the installation creates a user account exclusively associated with the distributed application, and
cause the one or more tasks to be executed by the subservient computing device using the user account exclusively associated with the distributed application.

20. The apparatus of claim 18 wherein the apparatus is configured to:
execute a web server that provides at least a portion of the performance summary to a user.
